(19) United States
(12) Patent Application Publication
(10) Pub. No.: US 2015/0341111 A1
(43) Pub. Date: Nov. 26, 2015

(54) COMMUNICATION LIGHT DETECTOR

(71) Applicant: Hitachi Metals, Ltd., Tokyo (JP)

(72) Inventor: Kanako SUZUKI, Hitachi (JP)

(21) Appl. No.: 14/684,340

(22) Filed: Apr. 11, 2015

(30) Foreign Application Priority Data
May 21, 2014 (JP) 2014-105290

(51) Int. Cl. H04B 10/079

(52) U.S. Cl. CPC H04B 10/0799

(57) ABSTRACT

A communication light detector is configured to draw a leak portion of communication light being transmitted via a communication light detecting adapter as a leaky light, receive the leaky light, and detect whether the communication light is being transmitted via the communication light detecting adapter or not. The communication light detector includes a light receiving element configured to receive the leaky light, and an optical filter configured to pass only the leaky light toward the light receiving element.

The present application is based on Japanese patent application No.2014-105290 filed on May 21, 2014, the entire contents of which are incorporated herein by reference.

### BACKGROUND OF THE INVENTION

1. Field of the Invention

This invention relates to a communication light detector for detecting communication light to visually identify a use/non-use state of an optical transmission line.

2. Description of the Related Art

In optical communication (light communication)-related facilities, in order to monitor the soundness of an optical transmission line or prevent human erroneous detaching of a connector, communication light in an invisible light region is detected to identify a use/non-use state (herein referred to as “communication state”) of the optical transmission line.

When the communication state of the optical transmission line is identified, a communication light detector is used, which is detachably attached to an adapter (herein referred to as “communication light detecting adapter”) formed with a light drawing hole thereon to draw a leak portion of the communication light being transmitted via that communication light detecting adapter as a leaky light, receive the leaky light through the light drawing hole, detect whether the communication light is being transmitted via that communication light detecting adapter or not, and output the communication state of the optical transmission line in such a form that humans can visually identify it.

Refer to JP-A-2009-145676, JP-A-2010-231082, JP-A-2011-013359, JP-A-2011-013360, and JP-A-2013-228678, for example.

### SUMMARY OF THE INVENTION

Now, when the communication state of the optical transmission line is identified by using the communication light detector, it is necessary to draw a leak portion of the communication light as a leaky light, and therefore reduce the occurrence of transmission loss resulting from the drawing of the leaky light as much as possible.

To satisfy this requirement, it is necessary to employ a light receiving element with a large and high-sensitive light receiving area to be mounted to the communication light detector, so that the communication light detector can detect whether the communication light is being transmitted or not, even when the intensity of the leaky light is low.

However, if the high-sensitive light receiving element is employed, the high-sensitive light receiving element may receive even external light such as outdoor sunlight, room fluorescent lamp light, etc., and have difficulty in purely receiving only the leaky light of the communication light. As a result, despite no communication light being transmitted, the high-sensitive light receiving element has been likely to erroneously operate and detect that communication light is being transmitted.

Accordingly, it is an object of the present invention to provide a communication light detector, capable of preventing erroneous operation caused by effects of external light.

According to an embodiment of the invention, a communication light detector, which is configured to draw a leak portion of communication light being transmitted via a communication light detecting adapter as a leaky light, receive the leaky light, and detect whether the communication light is being transmitted via the communication light detecting adapter or not, the communication light detector comprises:

a light receiving element configured to receive the leaky light; and

an optical filter configured to pass only the leaky light toward the light receiving element.

In the embodiment, the following modifications and changes may be made.

(i) The optical filter is configured to pass only light having a wavelength of not shorter than 850 nm and not longer than 1550 nm toward the light receiving element.

(ii) The optical filter comprises a dielectric multilayer film.

(iii) A light receiving portion of the light receiving element is sealed with the optical filter.

(Points of the Invention)

According to the invention, it is possible to provide the communication light detector capable of preventing erroneous operation caused by effects of external light.

### BRIEF DESCRIPTION OF THE DRAWINGS

The preferred embodiments according to the invention will be explained below referring to the drawings, wherein

FIG. 1 is a schematic cross sectional view showing a communication light detector according to the invention.

### DETAILED DESCRIPTION OF THE PREFERRED EMBODIMENT

Below is described a preferred embodiment according to the invention, in conjunction with the accompanying drawing.

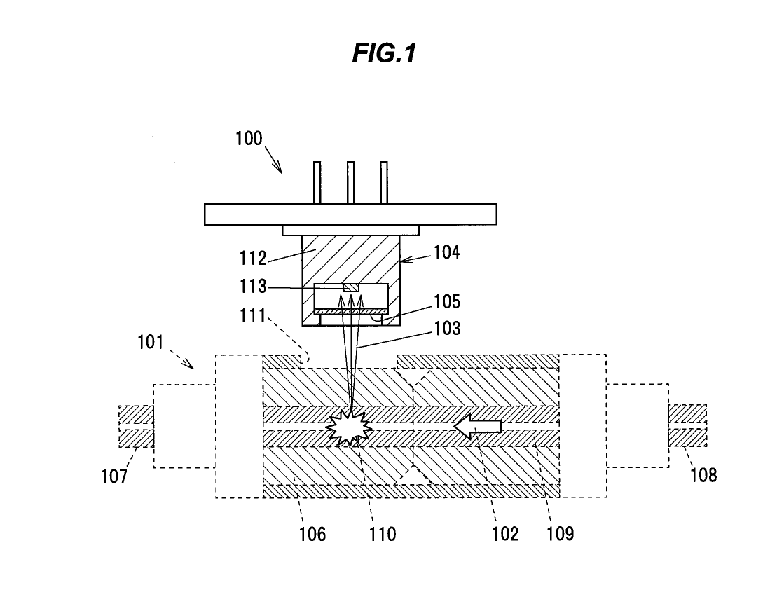

Referring to FIG. 1, a communication light detector 100 in a preferred embodiment according to the invention is configured to draw a leak portion of communication light 102 being transmitted via a communication light detecting adapter 101 as a leaky light 103, receive the leaky light 103, and detect whether the communication light 102 is being transmitted via the communication light detecting adapter 101 or not. This communication light detector 100 includes a light receiving element 104 configured to receive the leaky light 103, and an optical filter 105 configured to pass only the leaky light 103 (through the optical filter 105) toward the light receiving element 104.

It should be noted the communication light detector 100 further comprises an optical output unit configured to convert the leaky light 103 detected by the light receiving element 104 into an electric signal, thereby output a visible light, a driving circuit configured to drive the light receiving element 104 and the optical output unit, and an electric power source configured to supply electric power to the driving circuit, as described in e.g. JP-A 2009-145676. The detailed explanation of the optical output unit, the driving circuit and the electric power source are omitted herein.

The communication light detecting adapter 101 is configured to optically connect together a first optical fiber 107 and a second optical fiber 108, to which is attached a light transmissive ferrule 106 at an end, and thereby constitute an optical transmission line 109. The communication light detecting adapter 101 includes a light drawing portion 110 including a light drawing hole 111, which is formed for the optical transmission line 109, to draw the leaky light 103 through the light drawing portion 110. The light drawing portion 110 may have a known structure, such as a light detecting groove as disclosed in the above-listed JP-A-2009-145676, JP-A-2010-231082, or JP-A-2011-013359, or an axially misaligned portion as disclosed in the above-listed JP-A-2013-228678, and its detailed description is omitted herein.

The light drawing hole 111 is configured such that, when the communication light detector 100 is attached to the communication light detecting adapter 101, in order to prevent the light receiving element 104 mounted to the communication light detector 100 from receiving external light and being unable to precisely identify the communication state of the optical transmission line 109, the light receiving element 104 is fitted into the light drawing hole 111, to thereby prevent the external light from reaching the light receiving element 104. However, due to a small gap between the light receiving element 104 and the light drawing hole 111, it is difficult to completely prevent the light receiving element 104 from receiving the external light.

The light receiving element 104 comprises preferably a can-type photodiode including a can-shaped body 112, which is open toward the light drawing hole 111, and a light receiving portion 113, which is received (accommodated) in the can-shaped body 112. Reasons therefor are as follows: In the can-type photodiode, the light receiving portion 113 is sealed with the optical filter 105, so that the light receiving portion 113 is hardly subjected to damage due to effects of dust, moisture, etc. Also, since the light receiving portion 113 is less likely to be thermally affected than typical photodiodes which are sealed with resin or the like, the can-type photodiode has the most excellent reliability, even among various photodiodes.

The optical filter 105 is configured to pass only light having a wavelength of not shorter than 850 nm and not longer than 1550 nm, i.e. only the leaky light 103 of the communication light 102 (through the optical filter 105) toward the light receiving element 104. The optical filter 105 includes or is composed of e.g. a dielectric multilayer film. This dielectric multilayer film is a laminated dielectric film, and can easily achieve any optical properties, and is good in reproducibility and therefore excellent in mass production capability.

As described above, since the communication light detector 100 is equipped with the optical filter 105 configured to pass only the leaky light 103 (through the optical filter 105) toward the light receiving element 104, it is possible to shield the light receiving portion 113 from external light, securely receive only the leaky light 103 in the light receiving portion 113, prevent erroneous operation caused by effects of the external light, and identify the communication state of the optical transmission line 109 with high precision.

Although the invention has been described with respect to the specific embodiments for complete and clear disclosure, the appended claims are not to be thus limited but are to be construed as embodying all modifications and alternative constructions that may occur to one skilled in the art which fairly fall within the basic teaching herein set forth.

What is claimed is:

1. A communication light detector, which is configured to draw a leak portion of communication light being transmitted via a communication light detecting adapter as a leaky light, receive the leaky light, and detect whether the communication light is being transmitted via the communication light detecting adapter or not, the communication light detector comprising:
a light receiving element configured to receive the leaky light; and
an optical filter configured to pass only the leaky light of the communication light toward the light receiving element.

2. The communication light detector according to claim 1, wherein the optical filter is configured to pass only light having a wavelength of not shorter than 850 nm and not longer than 1550 nm toward the light receiving element.

3. The communication light detector according to claim 1, wherein the optical filter comprises a dielectric multilayer film.

4. The communication light detector according to claim 1, wherein a light receiving portion of the light receiving element is sealed with the optical filter.
